(19) United States
(12) Patent Application Publication
(10) Pub. No.: US 2006/0048695 A1
(43) Pub. Date: Mar. 9, 2006

(54) Bookmark

(76) Inventor: Steven Edward Ireland, Victoria (AU)

Correspondence Address: Thomas Kayden;Horstemeyer & Risley, Suite 1750, 100 Galleria Parkway, Atlanta, GA, 30339, US

(21) Appl. No.: 10/527,842

(22) PCT Filed: Aug. 13, 2003
(86) PCT No.: PCT/AU03/01014

§ 371 Date: Mar. 15, 2005

(30) Foreign Application Priority Data
Sep. 16, 2002 (AU) 2002951388

(51) Int. Cl. B42D 9/00

(52) U.S. Cl. 116/236

(57) ABSTRACT

A bookmark for use in indicating a line, column and page in an open book has a thin, flat, rectangular body (10) over which an encircling indicator (12) or indicators can move. The cuts defining the restraining part of each indicator have inwardly curving portions at their ends providing a degree of friction to temporarily restrain each indicator in position.

### FIELD OF THE INVENTION

This invention relates to a bookmark for use principally in indicating a place in a book. The word “book” is to be construed broadly as including magazines, manuscripts, a pile of papers, cards etc.

### PRIOR ART

Conventional bookmarks can be strips of paper, sometimes heavy paper and sometimes bearing a message of some sort. Alternatively they can be of flexible leather or cloth or plastics material.

Whatever material they are constructed from, known bookmarks merely indicate that the reader's place in a book is selected from some place on either page. It would be desirable if the bookmark indicated the relevant page and the relevant line or line number.

A number of bookmarks have attempted to incorporate line locating devices. Thus U.S. Pat. No. 727,572 Bauer discloses a bookmark having a substantially T-shaped body which incorporates a hook-like head to engage a page. The T-shaped body is attached to a stem upon which a shield is mounted. The upper straight side of the shield is used to mark the line desired.

U.S. Pat. No. 2,630,777 Johnson discloses a bookmark having two longitudinal slits therein. A tab is provided adjacent one end of the bookmark to engage a page of a book.

A horizontally slitted indicator piece is provided which engages the two slits. The indicator piece can be used to point to a particular word or line.

U.S. Pat. No. 3,137,268 Sager discloses a relatively complex bookmark which has a head portion having a base portion connected to a guide strip.

The head portion has projecting means connected with the base portion and tab means hingedly connected with said base for receiving the margin of a page.

A line locating member formed of flat, flexible material is provided with parallel slots which co-operate with the base portion.

U.S. Pat. No. 4,901,665 Carlin discloses a bookmark that locates a line, column and page in an open book having two or one column pages. The bookmark body is encircled with a slide with an index line. This index line can be moved by means of the slide to mark the line of a column. The bookmark body is provided on one side with two sets of indicia, thus L l (left page left column) and R l (right page left column). The opposite side is furnished with opposite indicia, thus R r and L r. This is a somewhat specialised solution to a particular problem.

U.S. Pat. Des. No. 170,467 Kolmin discloses a bookmark having two ends joined by a relatively elongate body. An elongated tab is shown. A slider is shown which only partially encircles the elongate body of the bookmark.

U.S. Pat. Des. No. 362,016 Faulkingham discloses a bookmark wherein a slider moves along two elongate slits formed in the body of the bookmark.

### SUMMARY OF THE INVENTION

The present invention relates to a bookmark which not only indicates the last page read but also provides an indicator or indicators directing the reader to a particular point or points in the text.

A principal object of the invention is the provision of a bookmark wherein the indicator is protected against movement as a consequence of jarring of a book in which the bookmark is located. It provides a simplified solution to this problem as well as stabilising the bookmark itself with respect to a book.

Accordingly this invention provides a bookmark for use with a book, said bookmark comprising:

a thin, flat, rectangular body having two long and two short edges;

an indicator or indicators each comprising a thin, flat collar in frictional contact with the rectangular body wherein the indicator or indicators are moveable up and down the rectangular body to direct the attention of a reader to a particular point or points in a text; and

a thin, flat, rectangular tab formed by two parallel cuts and a lower cut displaceable out of the rectangular body in such a region that the bookmark may be restrained by hooking it over the top of a page,

wherein the or each indicator is formed by cutting or punching blanks from sheets of material, each blank having two, parallel cuts of such a length that the rectangular body may be interlaced with the indicator or indicators and wherein each of the two parallel cuts curve inwardly for a short distance near their ends thus forming bearing surfaces upon which the long edges of the rectangular body impinge.

The function of the curved portions of the parallel cuts is to provide stability to the indicator by means of friction between the thin, flat, rectangular body and the indicator or indicators.

The parallel cuts forming the two sides of the tab desirably also curve inwardly near their ends so that the bookmark rests firmly on the page selected.

The bookmark may be constructed from a flexible, durable card material but is desirably constructed from a flexible, durable plastics material. If constructed from plastics material, it is desirably transparent or diaphanous.

The accompanying drawings illustrate the invention. Like reference numerals indicate like parts.

### BRIEF DESCRIPTION OF THE DRAWINGS

FIG. 1 is an isometric view of the front of the device illustrating an adjustable indicator in position on the body of the bookmark.

FIG. 1.A. is an enlarged detail of one side of the adjustable indicator as it engages the body of the bookmark.

FIG. 2. is an elevational view of the bookmark as it engages a book.

### DESCRIPTION OF THE PREFERRED EMBODIMENT

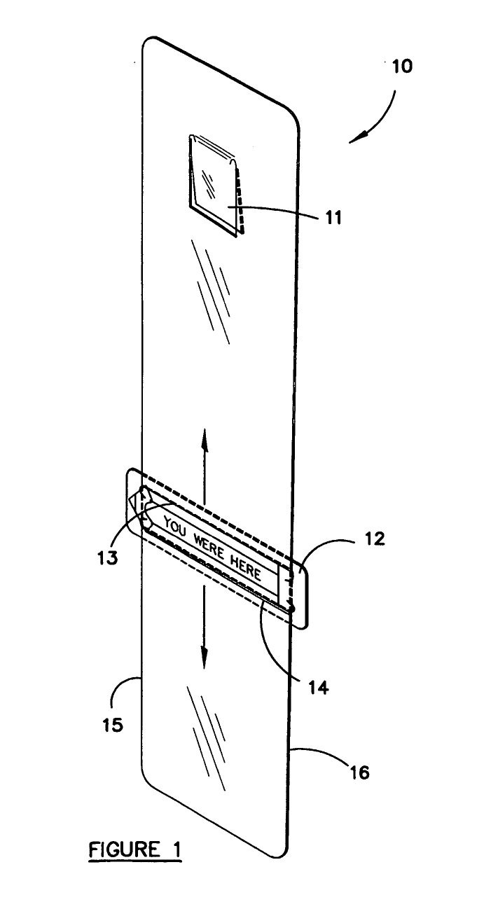

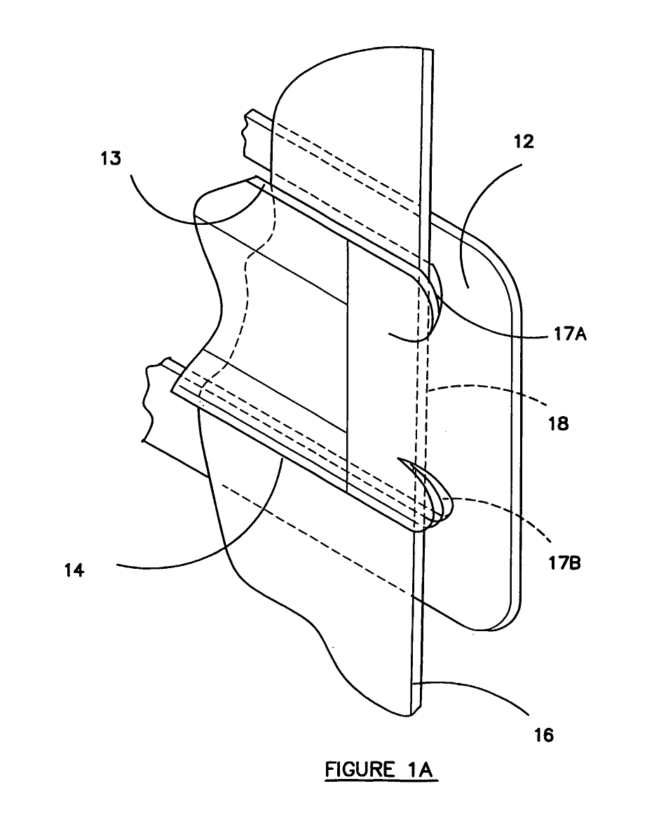

In FIG. 1. a generally rectangular bookmark 10 is shown provided with a tab 11 cut or punched out of the general body of the bookmark 10.

An indicator 12 is shown encircling the bookmark 10 and which may be made out of the same material as the remainder of bookmark 10. The indicator is provided with two cuts or punched lines 13 and 14 so that the indicator may travel along the body of bookmark 10 when pushed with a finger. Numerals 15 and 16 indicate elongate edges of bookmark 10 which position indicator 12 at some desired point.

Turning to FIG. 1A., cut or punched line 13 is shown as ending in curved portion 17A and cut or punched line 14 is shown as ending in curved portion 17B.

Numeral 18 indicates a portion of elongate edge 16 of bookmark 10. Curved portions 17A and 17B compress edge portion 18 as do the respective curved portions on the other side of the indicator portion (not shown). This slight compression increases position between the body of the bookmark and the indicator and protects the indicator from unwanted motion up and down the body of the bookmark.

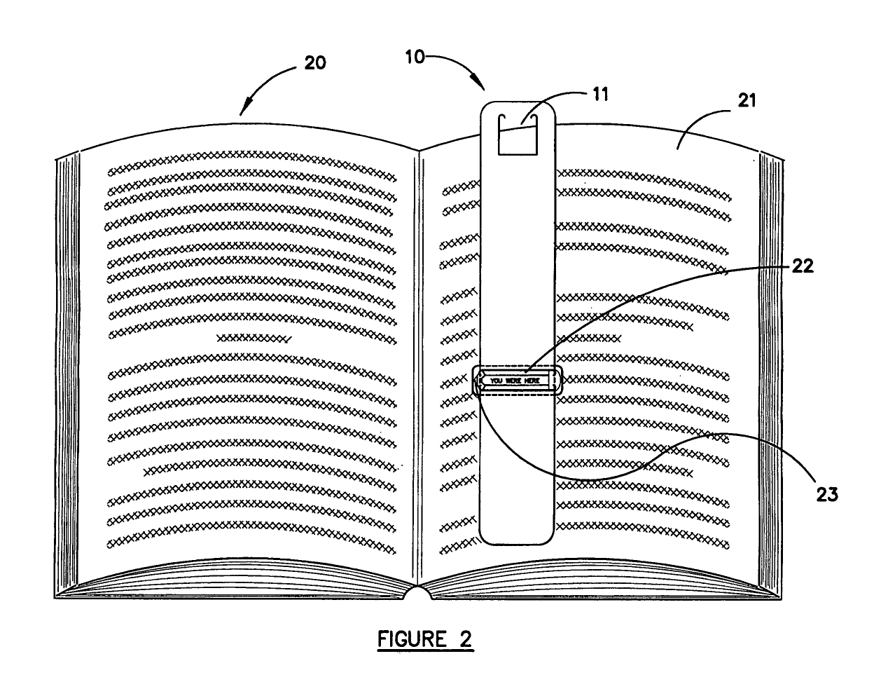

FIG. 2. illustrates the use of bookmark 10 with respect to book 20 and a particular page 21. In this case the movable means 22 is provided with an arrowhead 23 for greater convenience in pointing to a desired line in page 21.

1. A bookmark for use with a book, said bookmark comprising:
a thin, flat, rectangular body having two long and two short edges;
an indicator or indicators each comprising a thin, flat collar in frictional contact with the rectangular body wherein the indicator or indicators are movable up and down the rectangular body to direct the attention of a reader to a particular point or points in a text; and
a thin, flat, rectangular tab formed by two parallel cuts and a lower cut displaceable out of the rectangular body in such a region that the bookmark may be restrained by hooking it over the top of a page,
wherein the or each indicator is formed by cutting or punching blanks from sheets of material, each blank having two, parallel cuts of such a length that the rectangular body may be interlaced with the indicator or indicators and wherein each of the two parallel cuts curve inwardly for a short distance near their ends thus forming bearing surfaces upon which the long edges of the rectangular body impinge.

2. A bookmark as claimed in claim 1, wherein the parallel cuts forming the two sides of the tab also curve inwardly so that the bookmark rests securely on the page selected.
